(19) United States
(12) Patent Application Publication
(10) Pub. No.: US 2006/0004799 A1
(43) Pub. Date: Jan. 5, 2006

(54) Network content organization tool

(76) Inventor: Austin Wallender, Los Angeles, CA (US)

Correspondence Address: Alison L. McCarthy, Esq.;Mintz Levin Cohn Ferris Glovsky & Popeo, P.C., One Financial Center, Boston, MA, 02111, US

(21) Appl. No.: 11/157,388

(22) Filed: Jun. 20, 2005

Related U.S. Application Data
(60) Provisional application No. 60/581,155, filed on Jun. 18, 2004.

(51) Int. Cl. G06F 17/00

(52) U.S. Cl. 707/100

(57) ABSTRACT

A system for organizing data obtained over a network includes a user data manager configured to collect data associated with a first user of the system, a category data manager configured to collect data related to a category, the category information being integrated with the data associated with the first user, a link data manager configured to collect data associated with a link, the link providing access to content over the network, and an input management subsystem in communication with the category data manager, the user data manager, and the link data manager and configured to sort data related to at least one of the link and the category based on a first user-specified preference.

### RELATED APPLICATIONS

This application claims priority to U.S. Provisional Application Ser. No. 60/581,155, filed Jun. 18, 2004 and entitled, “Network Content Organization Tool,” which is herein incorporated by reference.

### BACKGROUND OF THE INVENTION

When compared to traditional broadcast media, such as televisions, newspapers, and the like, the internet provides limitless content through which to navigate when a user desires particular information. It is often times consuming to search through available content to get a desired result. Often, searching for particular content leads to hundreds of “hits”, some of which are not valuable to the searcher. Keyword searches often fail due to lack of specificity, inchoate knowledge of the desired result or simply poor spelling. Due to the widespread nature of the internet, many users arrive upon the same sites most suitable for particular purposes; however achieving that result can be time consuming.

### SUMMARY OF THE INVENTION

The invention provides a shared networked space for internet content management. The invention further provides television or other network content management options. The invention enables a user to manage, share, and discover content available on a network. An inventive database known and referred to herein as OPB (“Other People's Bookmarks”) pushes a user's links or choices to the forefront. For example, a user's highly regarded, recommended, and frequently used links are prioritized. Users organize content into categories, which become shared spaces where users have common content experiences, and share discovered content as well as opinions about content. The opinions are expressed in comments as well as numerical ratings. The opinions help sort the content, allowing the best content to be ranked highest. The opinions can also be used to filter content to specific keywords or level of usage or popularity. The automatic management, sorting, and filtering allow blending of the user's familiar bookmarks with the content in Other People's Bookmarks.

In general, in an aspect, the invention provides a system for organizing data obtained over a network. The system includes a user data manager configured to collect data associated with a first user of the system, a category data manager configured to collect data related to a category, the category information being integrated with the data associated with the first user, a link data manager configured to collect data associated with a link, the link providing access to content over the network, and an input management subsystem in communication with the category data manager, the user data manager, and the link data manager and configured to sort data related to at least one of the link and the category based on a first user-specified preference.

Embodiments of the invention may have one or more of the following features. The system can include a display management subsystem in communication with the input management subsystem and configured to manage an organization of the link within the category and present the organized data to the first user. The display management system can be configured to present the organized data associated with the first user to a second user. The display management system can be configured to limit a presentation of the organized data associated with the first user to the second user based on a privacy setting set by the first user.

Embodiments of the invention may further include one or more of the following features. The category can comprise a collection of links selected by the first user for presentation to the first user according to the at least one first user-specified preference. The user specified preference can include a rating assigned to the category to reflect a level of user interest in the category. The user-specified preference can include a rating assigned to the link to reflect a level of user interest in the link. The input management subsystem can be further configured to filter data related to the link based on the rating assigned to the link. The user-specified preference can include an access count assigned to the link to reflect a level of user interest in the link. The input management subsystem can be further configured to filter data related to the link based on the access count assigned to the link. The user-specified preference can be reflected by a count of a number of times the user selects the category. The input management subsystem can be further configured to filter data related to the category based on the count of the number of times the user selects the category. Data associated with a user of the system can include user link preferences, user category preferences, and user identification.

In general, in another aspect, the invention provides a method of aggregating content obtained over a network for use by a user, the content being accessible via a link that is selected by the user. The method includes extracting data associated with a first user and affiliated with a category determined by the first user, including data reflecting a status of the first user, extracting category-specific data associated with the category, retrieving a link based on a selection by the first user, the link providing a connection to content over the network, and aggregating first user data, the category-specific information and the link such that the data is sorted by at least one of the category-specific data and the link data to provide content to the first user.

Embodiments of the invention can includes one or more of the following features. The method can include displaying a format of aggregated data related to at least one of the category-specific data and the link data to the first user. The method can also include sorting the category-specific data or the link data according to a status of the first user. The method can also include filtering the data according to one of a category rating, a link rating, or a privacy setting determined by a selection by the first user. Further, the method can include displaying a format of aggregated data related to at least one of the category-specific data and the link data to a second user.

Features of the invention may include one or more of the following capabilities. The invention organizes a large amount of data from multiple sources. Data can be presented to the user in a usable fashion. Data can be presented in different formats for different users. Communication amongst users is increased and improved. Time spent searching websites, e.g., using keyword searches is decreased. The relevance of sites associated with a particular subject matter is increased. The relevance of sites associated with a particular group of users is increased. The invention can be analogous to a personalized online newspaper. The invention may resemble a personalized “best of” list. A set of content can be organized such that a user can specify the sorting of the content and allow peer sharing. Larger groups of data are viewable in a manageable format. Larger groups of data can be filtered by associated opinion data. The content to which persons have access over a network is more inclusive.

OPB provides an organization tool to networks for which objects have a unique identifier. Media other than web pages, such as television and other telecommunications systems, can be organized and accessed by a plurality of users according to the system herein.

The invention will be more fully understood after a review of the following figures, detailed description and claims.

### BRIEF DESCRIPTION OF THE DRAWINGS

FIG. 1A is a diagram of the database structure of the invention.

FIG. 1B is a flowchart of the data flow in the database structure of FIG. 1A.

FIG. 2 is a diagram of the database structure and a user interface of the invention.

FIG. 3 is a snapshot of a category sub-view according to the database of FIGS. 1A-1C.

FIG. 4 is a snapshot of a category sub-view according to the database of FIGS. 1A-1C.

FIG. 5 is a snapshot of a category sub-view according to the database of FIGS. 1A-1C.

FIG. 6 is a snapshot of a categorization according to the database of FIGS. 1A-1C.

FIG. 7 is a snapshot of a categorization according to the database of FIGS. 1A-1C.

FIG. 8 is a snapshot of a categorization according to the database of FIGS. 1A-1C.

FIG. 9 is a snapshot of a categorization according to the database of FIGS. 1A-1C.

FIG. 10 is a snapshot of a categorization according to the database of FIGS. 1A-1C.

FIG. 11 is a snapshot of a categorization according to the database of FIGS. 1A-1C.

FIG. 12 is a snapshot of a categorization according to the database of FIGS. 1A-1C.

FIG. 13 is a snapshot of a categorization according to the database of FIGS. 1A-1C.

FIG. 14 is a snapshot of a categorization according to the database of FIGS. 1A-1C.

FIG. 15 is a snapshot of a categorization according to the database of FIGS. 1A-1C.

FIG. 16 is a snapshot of a categorization according to the database of FIGS. 1A-1C.

FIG. 17 is a snapshot of a categorization according to the database of FIGS. 1A-1C.

### DETAILED DESCRIPTION OF THE INVENTION

The features and other details of the invention will now be more particularly described with reference to the accompanying drawings. It will be understood that particular embodiments described herein are shown by way of illustration and not as limitations of the invention. The principal features of this invention can be employed in various embodiments without departing from the scope of the invention.

Embodiments of the invention provide a database configured for categorizing and organizing data obtained or accessed on a network, such as the internet. The database presents the user with customized views of some or all content in the database. By altering criteria, the database presents collections of links that serve different functions to the end user via a user interface. For purposes of the following, the database can be referred to as “Other People's Bookmarks”, or “OPB.” The database can be a communal, online database, enabling the sharing of links, content, or choices among friends, co-workers, and enthusiasts of similar content, as well as access from different computers or other media. Applications of the invention can be used with a network, such as a WAN or a LAN, internet site links, television channel options, and other media connections or addresses for user-selected choices. Other embodiments are within the scope of the invention.

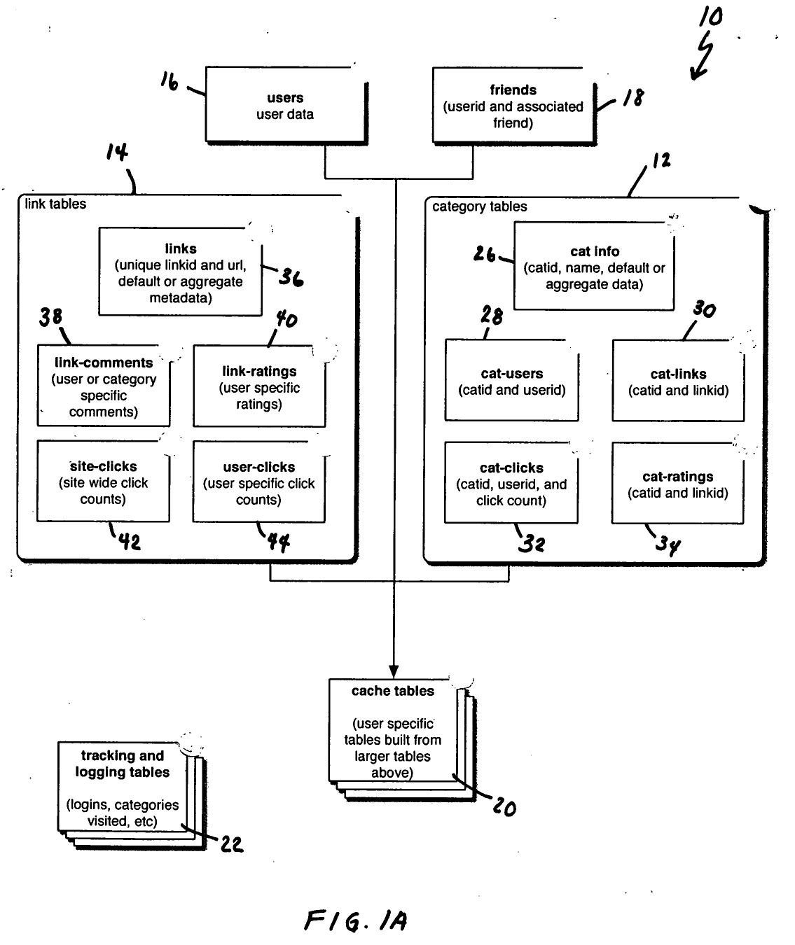

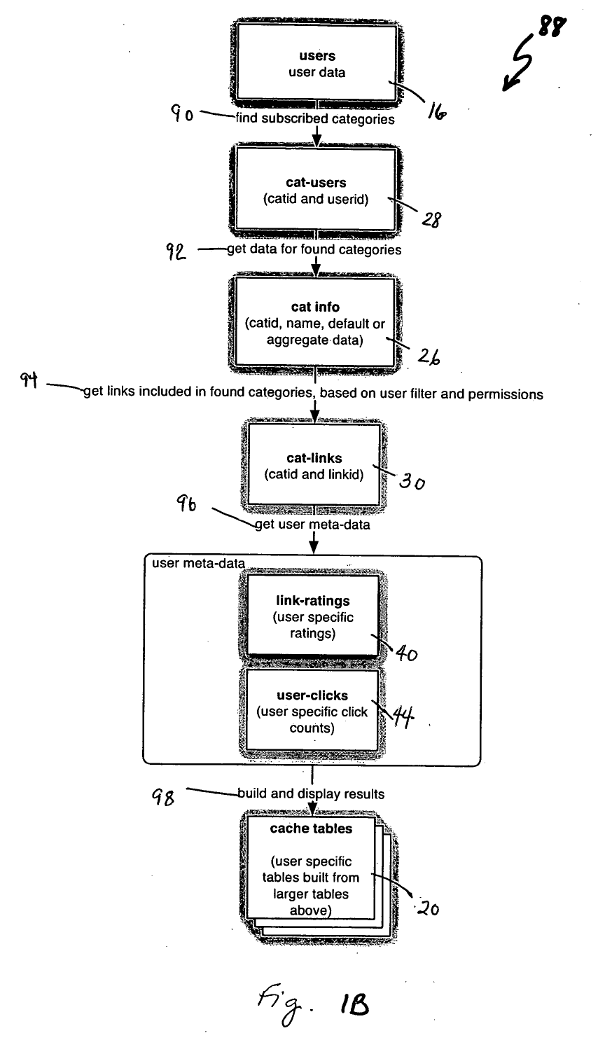

Referring to FIG. 1A, a database 10 for managing user links for use in networks includes category tables 12, link tables 14, user tables 16, friends tables 18, cache tables 20 and logging tables 22. The tables 12, 14, 16, 18, 20, 22 interact with one another in the database 10.

The category tables 12 include category information tables 26, category-user identifications tables 28, category-link identifications tables 30, category-click identifications tables 32 and category-ratings identifications tables 34. A category is a collection of pointers to other content, i.e., a category contains a list of links to substantive content available over a network. Categories are identified in the category tables 12 such that the categories are cross-referenced with the user who has identified the category, the link identification that is listed in the category, the click count for a user in a category, and the rating assigned to a category by a particular user.

The category information table 26 contains a category ID, the category name, owner, default descriptions and ratings. The category information table 26 may also contain information about the contents, such as a number of links, subscribers (i.e., a user who has subscribed to a given category, such as by marking a category as one that will be revisited), and editors (i.e., a subscriber with privileges to add and subtract links from a category, or approve or decline links added by other users), the date the category was created and the date of the latest addition to a category. The category users table 28 pairs a category ID (cat ID) and a user ID to indicate subscription to a category. Additional subscription related information, such as privacy, permissions, date subscribed, and filters are also stored in the category users table 28.

The category links table 30 is an index table with a link ID and a cat ID, signifying that a link is in a category, the date a link is added to a category, and a privacy rating for access to a link within a category. For example, a link may be marked as having a private status, suggested status, or public status. A link having a private designation is available only for the user who added the category. A link having a public status is available for all users. Semi-private status levels, such as suggested status, can make a link available to editors and original submitters, for example. Editors can approve a link to make it public, or decline a link to make it private. Additional levels of privacy can also be included. The category links table 30 also contains the user ID of the user who added the link, and the user ID of the editor who approved the link.

The category clicks table 32 contains a click-count for a given user ID and cat ID storing the number of times a user has accessed a category and the last time a category was accessed. The category ratings table 34 contains a cat ID and a user ID, and a user-specific rating.

The link tables 14 include link identifications table 36, link comments table 38, link ratings table 40, site-clicks table 42 and user clicks table 44. Each of the link tables 36, 38, 40, 42, 44 may include user-specific information or category specific information that is stored in the database 10. Each of the links tables 36, 38, 40, 42, 44 communicate with one another within the link tables 14. The links table 36 is a table containing a unique link ID, a unique link URL, and default name, comment and rating. The defaults are initially set by the user adding the link, but can be overridden. For example, if the title of the link http://www.espn.com/ was added as “ESPN—The worldwide leader in Sports”, but most users shorten the title to “ESPN”, an algorithm updates the default to reflect the consensus.

The link comments table 38 contains metadata about the link, e.g., a customized link name and/or comment, as well as privacy settings. The data is attributed to a specific user, category, and link ID. The same user may have different comments for the same link in different categories, and the same link may have different privacy settings in different categories. If the user has specific customizations, they will be displayed. If specific customizations do not exist, the category defaults (specified by a user ID of 0) are displayed. If there are no customizations for the specific category, the defaults from the links table 36 are displayed. The link ratings table 40 contains a rating for a specific link ID and user ID, as well as a timestamp of the date it was rated. The link ratings table 40 and the link comments table 38 can be a single table.

The site clicks table 42 contains a link ID as well as a click count. The site clicks table 42 is the site-wide counter for link usage. The site clicks table 42 also contains a timestamp of the last time the link was clicked, as well as other site-wide link-specific data. The site clicks table 42 may be modified, or another table added, to allow for category-specific click monitoring. The user clicks table 44 contains a click count for a given user ID and link ID. The user clicks table 44 stores the number of times a user has clicked on a link.

The user table 16 includes user information, such as the user name, user ID, email address, and various preferences that are stored in the database 10. The friends table 18 tracks and indexes user IDs that are marked by a given user, thereby allowing the user access to the specified user's links and categories, as well as other user-specific information. For example, a user can browse the links of one or more friends as a meta-category, or send links to groups of friends. The friends table 18 can also provide access control, so that users designated as friends can access certain links and categories.

The cache tables 20 combine data from the larger data tables to create smaller user specific data sets. For example, a cache table may be created for a specific user view of a specific category, merging the names, descriptions, ratings, click counts, access dates and other metadata for themselves, their friends, and site-wide aggregates. The cache tables 20 communicate with the user interface to display the data for the user. There may also be cache tables for meta-categories, such as a user's top links or the most recent additions to the database. The logging table 22 tracks and logs information related to the logins by a user and the categories a user visits, for example.

Referring to FIG. 1B, a process 88 of interacting with the database 10 to create a cache table by drawing information from the link tables 14 and the category tables 12 includes the stages shown. The process 88, however, is exemplary only and not limiting. The process 88 can be altered, e.g., by having stages added, removed, or rearranged.

At stage 90, having data on a user, the IDs of the subscribed categories are extracted, along with the user-specific rating and the user's editorial status. At stage 92, the category specific information is extracted, such as aggregate click count and aggregate rating. Given the user's editorial status, links are retrieved, as shown at stage 94. At stage 96, metadata specific to the link and the user and/or category is retrieved including, but not limited to, link rating and frequency of use by a user. The table is built and sorted for display at stage 98.

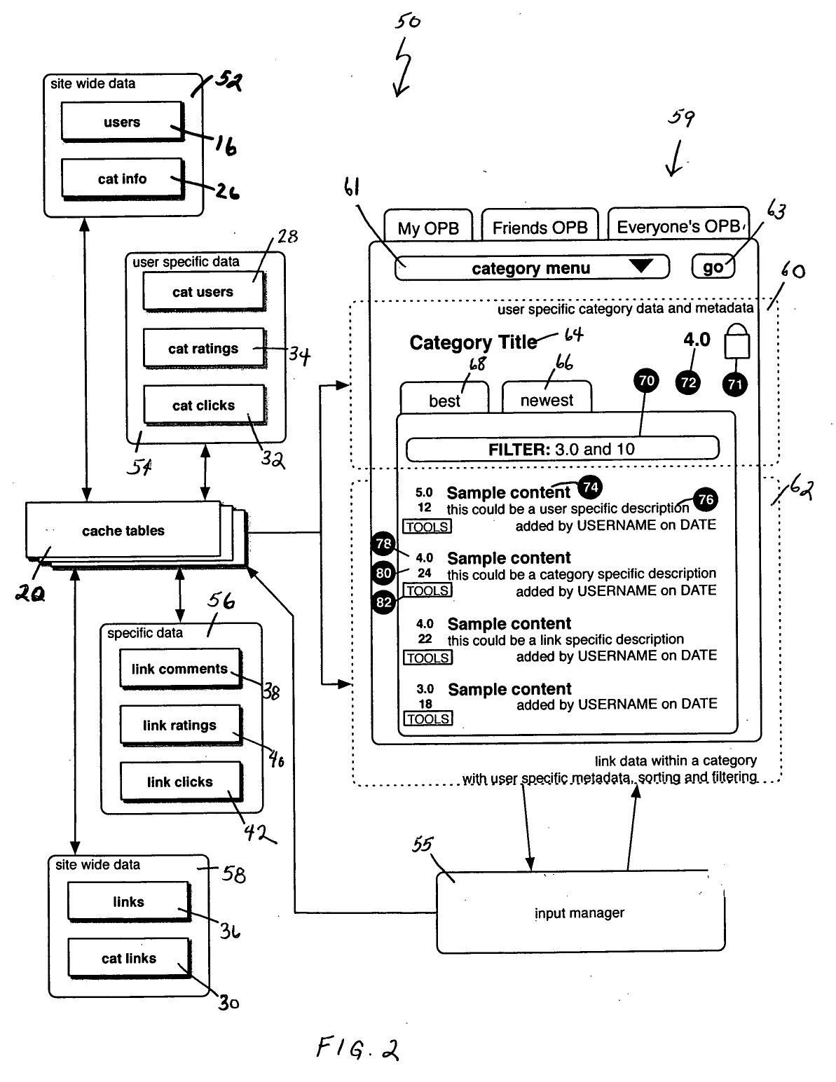

Referring also to FIG. 2, cached tables are configured to manage groups of information in the database and display it to the user via a user interface module 50. The cache tables combine information from aggregate sources (such as click averages, predicted ratings, etc.) as well as user-specific information, both for the user as well as the user's friends. These values are then presented via the user interface 59. A site-wide category data manager 52 collects data, and integrates with user specific category data via the user data manager 54. Data is cached via a cache table 20 and may be displayed in the user interface 59, or used to predict other values. For example, the number of links added by the user and the number of accesses to this specific category in relation to other subscribed categories can be used to predict and suggest a rating for the category. For example, items such as the user's rating of the category 72, the number of accesses, the number of links, and the user's filter settings for the various display views 70 can be used to predict a rating.

Similarly, link data is pulled from a site wide data manager 58 and integrated into cache tables 20 via a personalized data manager 56. The link data includes user specific link titles 74 and comments 76, user specific ratings 78 and access counts 80. If user specific data is not available for the items, category specific data is substituted. For example, if a user has not rated a link, but other subscribers to this category rate a link highly, the database 10 suggests a high rating for the link, bringing it higher on the list. The suggestion is weighted based on the ratings and access counts of category editors, and also factors in the data from other subscribers to the category. Site wide data is considered if the data in the category is insufficient to make a prediction.

The user site wide data manager 52 uses data from the users tables 16 and the category information table 26. The user specific data manager 54 uses data from the category users table 28, the category ratings table 34 and the category clicks table 32. The link specific data manager 56 uses data from the link comments table 38, the link ratings table 40 and the link clicks table 42. The link site wide data manager 58 uses data from the links table 36 and the category links table 30. Each of the managers 52, 54, 56, 58 may include tables in addition to those tables listed herein. Further, each of the managers 52, 54, 56, 58 may include tables instead of those listed, or tables listed may be removed.

Display, sorting and filtering of the information chosen by the user is handled by the input manager 55. This includes, but is not limited to, resorting and displaying the link content in best 68 or newest 66 order, re-filtering data once the filter settings 70 are changed, changing the user rating 78, incrementing the access count 80, as well as any of the other input functions, such as addition of a link or category, deletion of a link or category, copying of a link, moving of a link, editing link information such as title or comment, sending of a link to another user or users, approval of a link, and denial of a link. The functions can be in the tools menu 82.

The user interface module 50 further includes a category browser 60 and a link browser 62. The category browser display 60 includes a window for the display of category information. The link browser display 62 includes a window for the display of link identification. The link browser can display user specified categories, or data driven meta-categories. Categories are user-designated groups of links, either created or chosen by the user. Links are added and/or subtracted by multiple users. The links can be sorted and displayed by personal rating and usage, addition date, access permissions or other metadata. Meta-categories are configured to systematically select links based on given criteria and display the chosen links accordingly. For example, the meta-categories can contain the newest links from a user's categories, the best links from a group of users, or search results within a set of categories.

The database 10 is configured to allow access to the categories 64 to a user. For example, a user can log on with a login prompt to gain access to the categories 64. The categories 64 display links that can be selected for connection to a particular network resource.

The category browser window 60 includes user specific category data and metadata. A category menu 61 allows selection of a category from one or more user categories set up by the user. A category title field 64 displays the chosen category. Categories include sub-tabs 66, 68, such as “best” and “newest” by which links are sorted. The category view 60 displays links added to a given category by the owner or editor of the category. Categories chosen from the categories menu 61 are marked as public, semi-public or private, as designated by the user. Links associated with a category are displayed in the link display 62 when a category is selected from the category menu 61. The category may have a title and may have a description. Public categories include a title and description listed in a searchable directory. A user can subscribe to a public category, and invited users can subscribe to a semi-private category.

Users can browse categories they have permission to access. The category is presented with aggregate metadata based on the subscribed users. For example, a user can click on an “Add to my OPB” button to subscribe, and OPB begins to track the user's usage of the links in the given category. The category appears in the user's personal category list, and personalized metadata is preserved. The category list 61 is a navigational tool for the user. Subscribed categories are listed alphabetically, and can be grouped in order of the user assigned rating. Any unrated categories are listed together at the end of the list. Within these groups, the categories are ordered alphabetically. The placement of a “go” button 63 in proximity to the dropdown allows the user to quickly “flip” through categories, reminding themselves of their favorite sites, without moving the cursor. Sorting the categories by rating allows the user's favorite categories to be displayed first.

Users of the database 10 interact with the user interface 59 to access, organize, display and share links belonging in a category or a number of categories. Referring again to FIG. 2, a mode of viewing links in OPB is via categories. Categories are collections of pointers to other content. The type of content is limited only by what can be referenced via a uniform resource locator, or URL. For example, OPB can work with HTML documents and video or audio content on a set-top box. Additionally, OPB categories can contain pointers to other OPB categories.

A user can add links to a subscribed category. The links appear in the user's display of the category 60, but they will not be included in the category for other users until an editor of the category approves the link. The link is marked as “suggested” until it is approved. If it is declined, the link is marked as a private link, and included in the category for the user who added the link, but not for other users.

The owner (i.e., the creator of a category having permission to add and subtract editors) of a category can share editorial control with other subscribers or editors who also have the ability to add or delete links. The ratings and access counts of the editors are given weight in the calculation of the default rating for the link in the category.

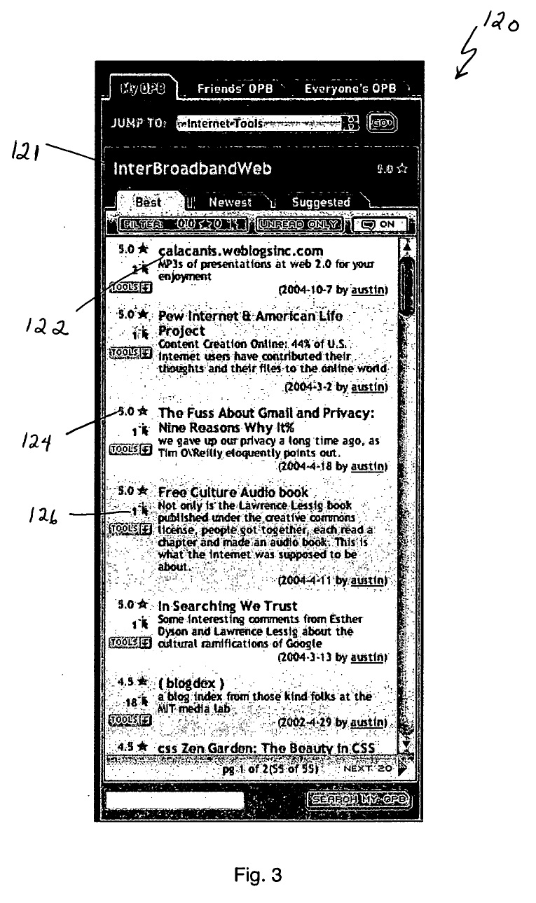

The category view has three possible sub-views: BEST, NEWEST, and SUGGESTED. Referring to FIG. 3, the BEST sub-view 120 is shown. The BEST view lists the user's most desirable links 122 in a category 121, a rating 124 and a number of clicks 126. The links 122 are sorted by the user rating 124 (substituting an aggregate or recommended rating if the link is not rated by the user) and sub-sorted by the user clicks 126. If the user clicks 126 and ratings 124 are equal, the links are presented in order of addition to the category, with the newer link first. The BEST view 120 is user-specific, i.e., the same category will present different links in a different order to different users. Users with overlapping but not identical interests can share categories and alert each other to content that other subscribers may enjoy.

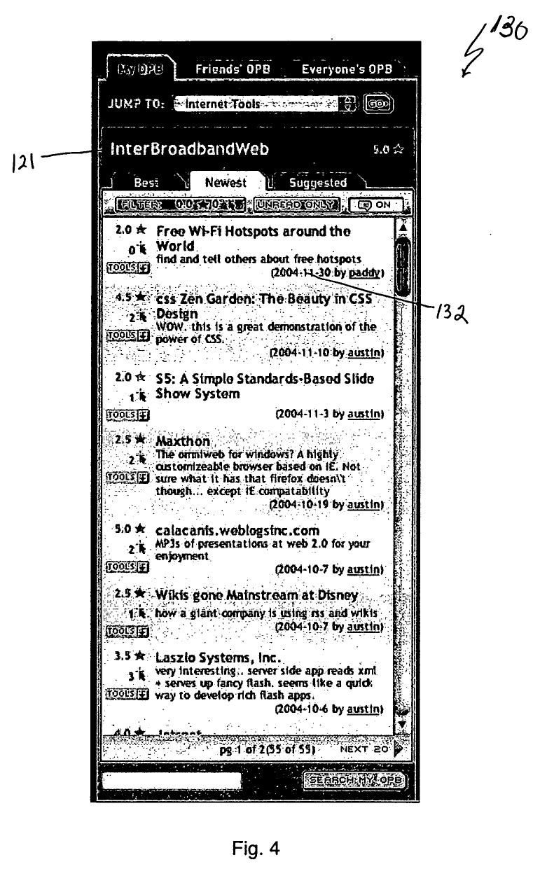

Referring to FIG. 4, the NEWEST view 130 lists the most recently added links in the category, sorting by a date added to the category field 132. The NEWEST view 130 is useful for the user who wants to peruse the latest additions to a category, but also for a user who cannot remember details of a specific addition. For example, if a user had recently added a site that had really well written movie reviews, but could not remember the name of it, a quick click on the NEWEST tab of his movie category reveals the site.

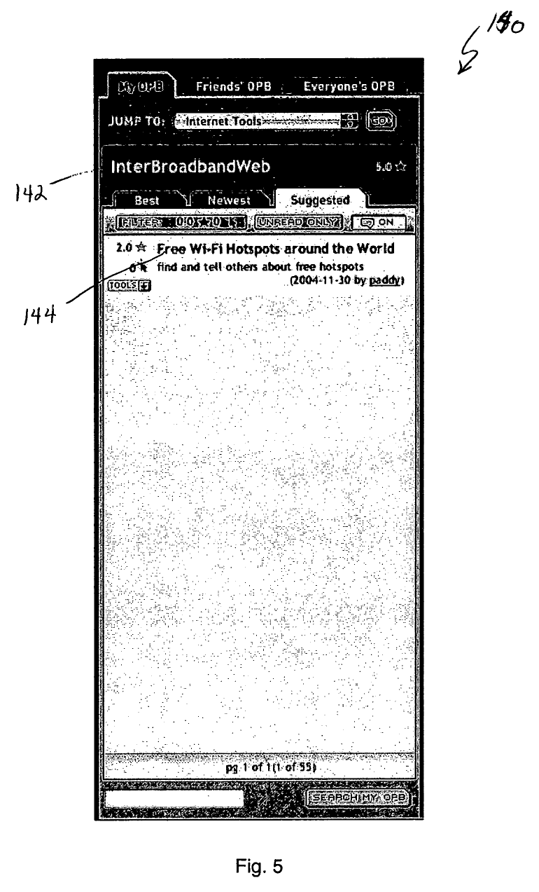

Referring to FIG. 5, the SUGGESTED view 140 is shown. The SUGGESTED view 140 is available to users with editorial permissions to a category 142. The SUGGESTED view 140 lists the links that have been suggested or recommended to the category and are awaiting editorial approval. The links 144 are sorted by default rating, and sub-sorted by the date added. If no unapproved suggested links exist at that moment, the SUGGESTED view 140 does not exist. The SUGGESTED view 140 allows category editors to approve or decline links suggested to the category. They can view the substantially new content, and decide if it is appropriate for their category.

If suggested links exist, the sub-view will default to the SUGGESTED view 140 upon category selection. If no suggested links exist, but new (i.e., unseen by the current user) links exist, the NEWEST view 130 is the default. Alternatively, the BEST view 120 is the default. OPB can include other category sub-views.

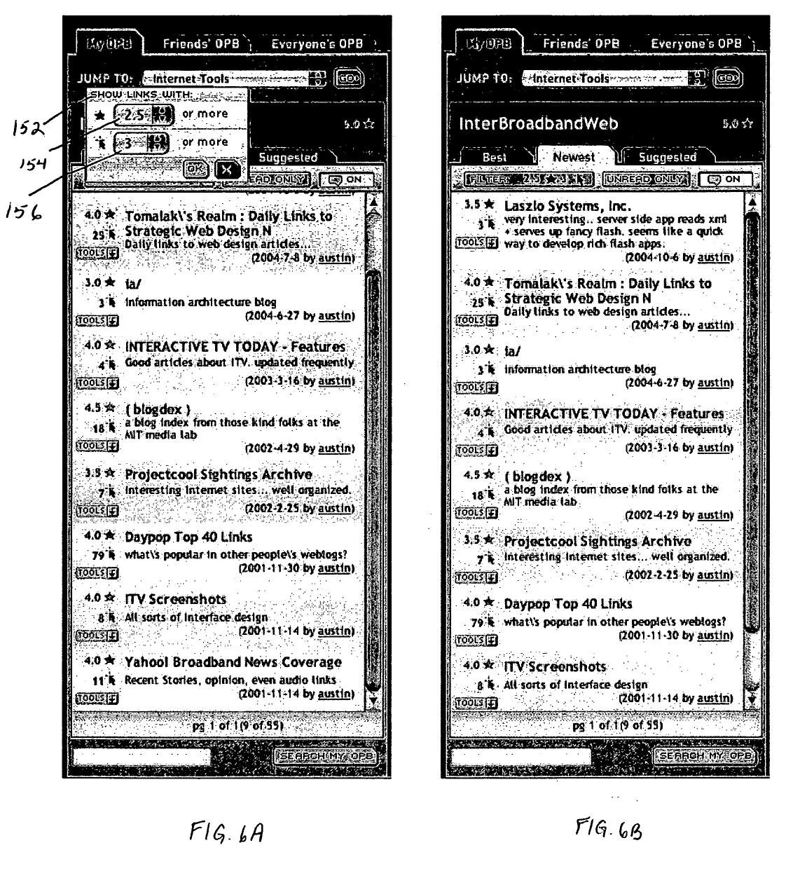

With reference to FIGS. 6A and 6B, category filters 152 allow users to customize what content is shown, based on rating and usage. An OPB screen includes a filter option 152 having a field entry for a rating value 154 and for a number of clicks value 156. A user enters a desired value in one of the fields 154, 156 and the links in a category, such as the links in FIG. 6A, are narrowed to a filtered list of links, as shown in FIG. 6B. For example, if a user is only casually interested in a high traffic category, a filter of 4 stars allows the best links to be visible. If a category contained many links, but only a handful were of interest to the user, a filter of 5 clicks would hide sites that had not been clicked on at least five times by the user. Other embodiments may include alternate ways of filtering, such as using the number of clicks of other users, hiding or showing the additions of specific users, showing links containing certain words or word fragments in the link titles or descriptions, or showing only links commented on by specific users.

Separate filters are used for each sub-view of a category. A user may have a filter of 2 stars and 5 clicks in the BEST tab 120, and a filter of 4 stars and 0 clicks in the NEWEST tab 130. For example, a user may wish to have access to all “his” links in the BEST tab 120, but can still see the best of the new additions in the NEWEST tab 140 by using the filters.

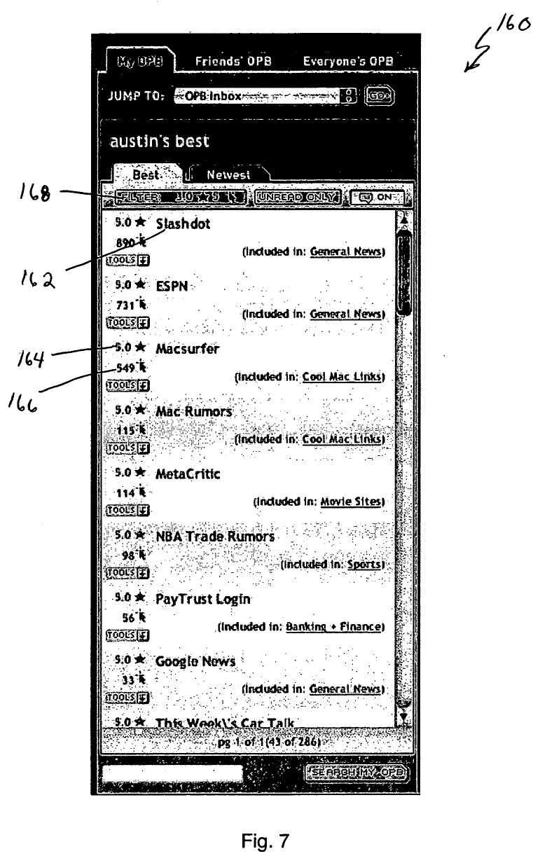

Referring to FIG. 7, the database 10 employs meta-categories to aggregate data from subscribed categories to alter the format of the data. Meta-categories are user-specific. In FIG. 7, the TOP LINKS meta-category 160 is illustrated. The TOP LINKS view 160 selects links 162 that the user has clicked on from all of the categories to which the user is subscribed, presenting the links in rating order. For example, the links can be presented from highest to lowest rank based on a rating 164 and a number of user clicks 166. If multiple links have the same rating 164, the links are sub-sorted by the number of times the user has clicked on the link. A user definable filter 168 can limit the selection criteria to links clicked more or less than a certain number of times, or links above or below a certain rating.

The TOP LINKS view 160 is a meta-category that can be sorted and filtered. The TOP LINKS view 160 gives the user a personalized “greatest hits” of the web. Frequently visited sites are presented in one place. If a user visits technical sites, sports sites, news sites, weather sites, and comic sites every morning, a variety of sites are presented to the user through the TOP LINKS view 160. The information is updated substantially consistently as the user uses OPB. Using the BEST and NEWEST tabs, and the filter, the user can view the links from the user's subscribed categories in a number of formats. For example, the BEST view with a filter of three stars or higher, and ten clicks or higher shows the user favorite sites that have been visited more than one time, generally those sites with changing content or that merit repeat viewing.

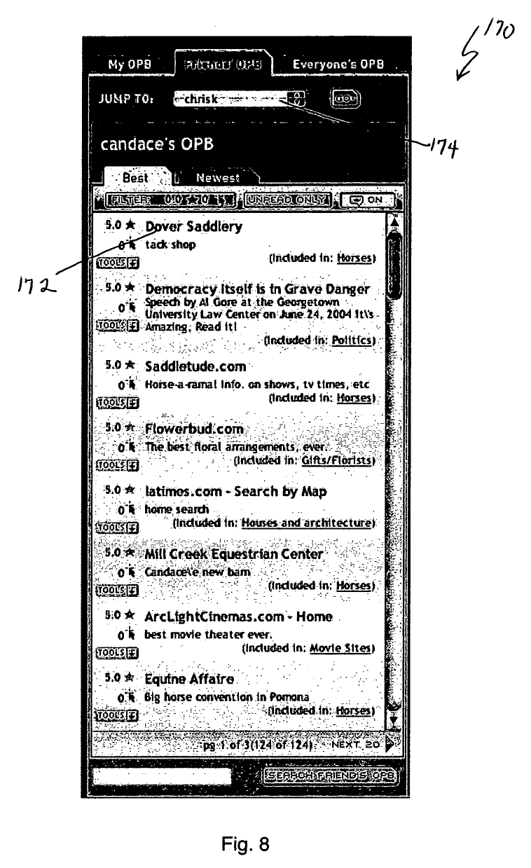

Referring to FIG. 8, a USER LINKS meta-category 170 shows a sampling of a user's links 172. Due to privacy concerns, the USER LINKS view 170 is customizable by the user whose links are being shown. The views can be available to all users, another group of authorized users or “friends” only, specified users only, or only the user. Link permissions override the USER LINKS view 170 permissions (i.e., if a link is marked as private it will be omitted from these views to everyone except the user). The view 170 includes a drop-down menu 174 to quickly access the links 172 of a user designated as a “friend” by the user. Other embodiments may include metadata based filtering, similar to the category views, discussed above. The USER LINKS meta-category 170 includes sorting and filtering capabilities, as discussed with other categories. The links displayed in the USER LINKS meta-category 170 reference the category or categories that contain those links.

Categories in OPB can be browsed in a number of ways. For example, a user may browse categories by browsing Popular Categories, which sorts categories by different types of popularity. Each of the sub-views discussed above can be affected by a filter, which toggles between all categories, and just the categories subscribed to by “friends”. Further, a “highest rated list” lists categories sorted by the ratings that users assign to the category. “Most links” lists the categories that have the most links. “Most activity” lists the categories that have had the most links added to them recently. “Most subscribers” lists the categories with the most subscribers.

A “similar categories” listing shows categories that are similar to a given category. The categories may contain one or more overlapping links, or may have names and/or descriptions that contain overlapping terms.

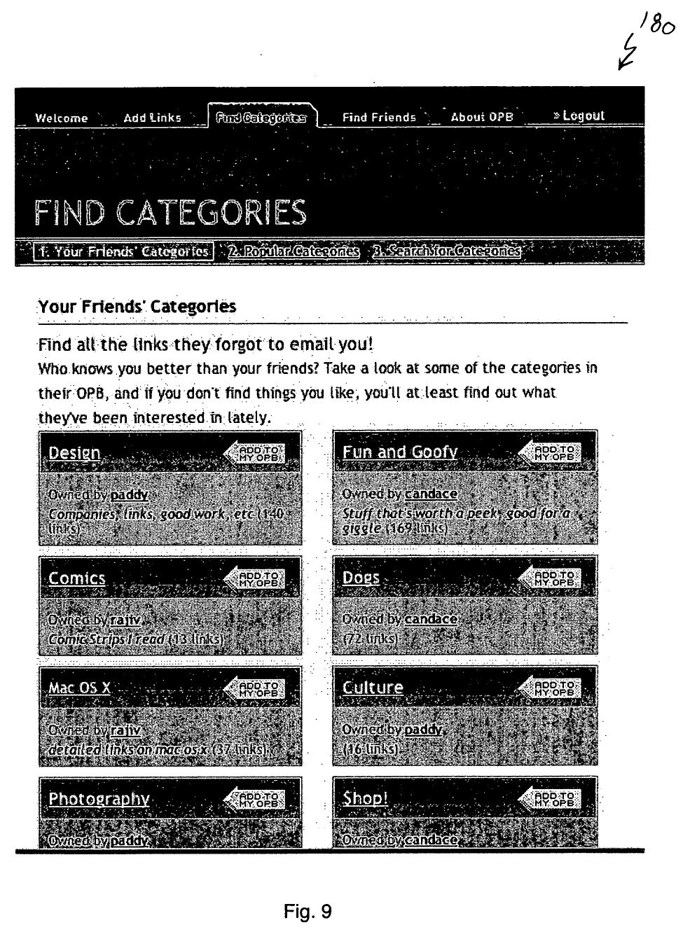

A “friend's categories” listing 180 is shown in FIG. 9. The “friend's categories” listing 180 displays a list of categories that the friends of the user subscribe to, but that the user may not subscribe to. The content of the list depends on the settings specified by the user being displayed. Specific categories may be excluded based on category privacy settings, or a user's privacy settings, i.e., a user may choose to hide the fact that they subscribe to a category. In this view, the highlighted description would be that of the associated user. If the user has not added a customized description for the category, the category default (usually the owner's description) is shown. The list may be sorted by a wide variety of metadata, both aggregate and specific to the friend who subscribes to the category or the editors of the category. Data includes category ratings, user accesses, the number of links in a category, the number of rated or visited links in the category, aggregate ratings of links included in the category, and the date of the most recent addition, for example.

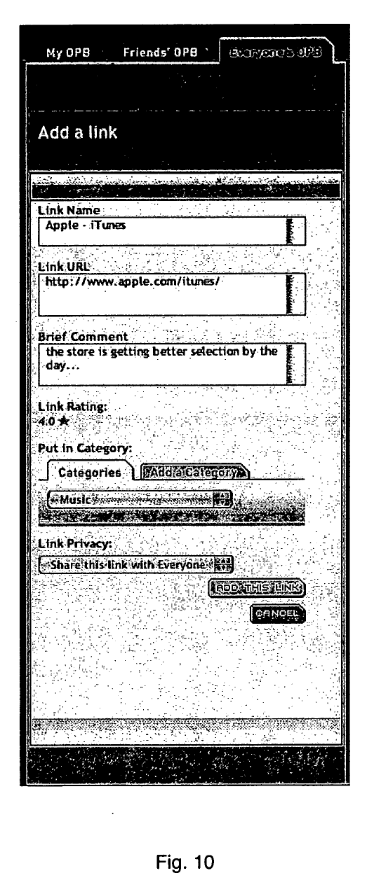

The OPB database provides the ability to take many different actions with the links and their associated metadata. Referring to FIG. 10, a view of a link being added to the database is shown. Addition of a link to the database may be accomplished by typing the URL and title into the form. Alternately, a JavaScript installed in the toolbar of the user's browser can be used to automatically send the URL and title (if specified) to OPB, which then presents the data to the user. The user also chooses a category for the link. If no appropriate category exists, users can create a new category when adding, copying or moving a link. The user can name the category, give it a brief description, and determine to share the category with other users. In alternative embodiments, link data can be embedded in a URL or XML-RPC call for automated addition from an outside script or program.

Existing data can be used to automatically fill in metadata, i.e., the user's most recently selected category is automatically selected to receive the link, and comments can be suggested based on the comments of previous users of the URL. Similar automation of data input is possible in other cases, i.e., passing of program guide data for a television episode, or filling in data from a remote source, such as comparison to a program database based on time and channel of input, or the URI itself, such as an ISBN number or Tribune Media Services ID (TMS ID). The automation enables the addition of categorization of a link with, for example, two clicks.

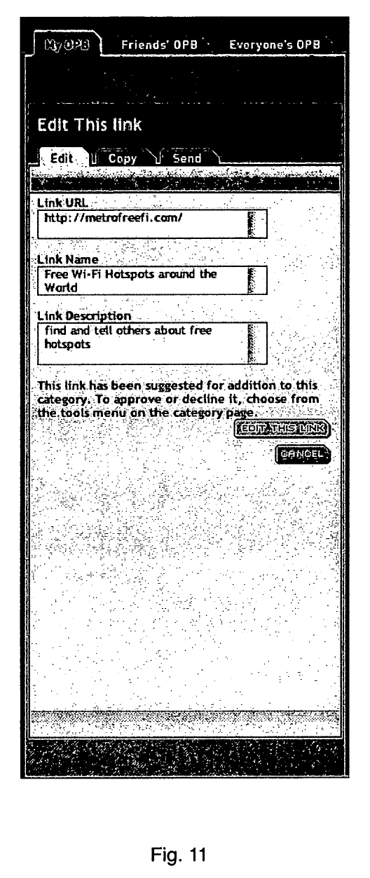

Referring to FIG. 11, a link title and comment can be edited. The privacy level of the link can be set, making association with the link and personal metadata available to only those people specified, as desired.

A link can also be marked as “dead”. While basic subscribers cannot edit link addresses in categories they do not edit, a user can alert the editors that a link appears to point to an incorrect location by marking it as a “dead link” and perhaps suggesting a corrected URL. The original adder, a category editor, or an OPB staff member can all edit and “revive” the URL. If made by OPB staff, these changes will be mirrored site wide. Otherwise, the change will be made for the category, and editors of all other categories that contain the link will be notified, and can make their own changes.

A link can be marked as “new”. If a link changes dramatically, the editor of a category can mark the link as “new” alerting his subscribers that something interesting has happened to it. The editor can also write a new comment about what has changed and why it is worthy of another look. In addition, users can mark links as new for themselves, returning the link to zero clicks. This affects how the link is sorted in categories and meta-categories.

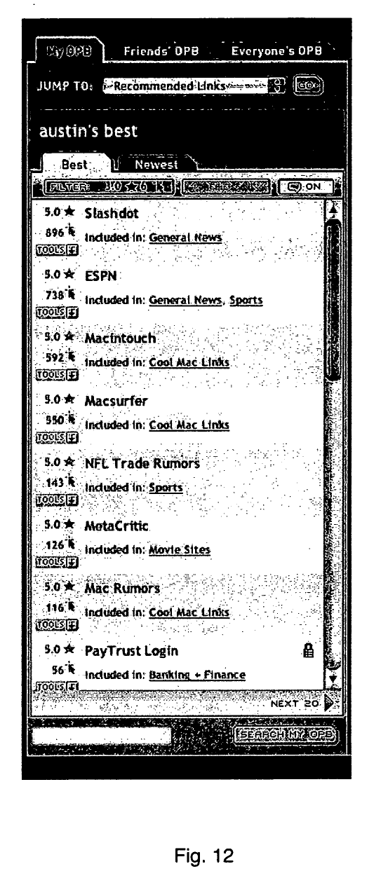

With reference to FIG. 12, a link can be rated or deleted. A user can add an opinion about the link to the database by rating the link. These ratings will be used to calculate the default ratings both category wide and site wide. A user can delete a link from a category. If the user is not an editor of the category, the link is hidden from view. If the link existed in that category, and is removed by an editor, it is removed from the database altogether. Users can choose to be notified when links are removed from categories they are subscribed to, so access is not lost.

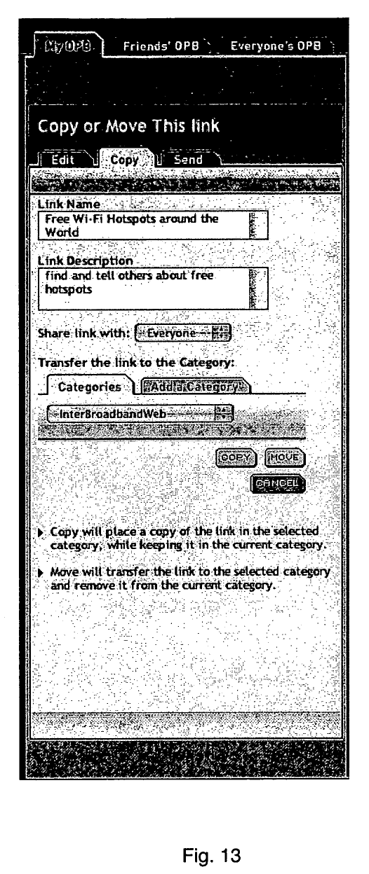

FIG. 13 illustrates the ability to copy and move links. The user may copy a link from any category to any other. If the user has editorial privileges of the category, he may move the link—removing it from the present category and adding it to the new category. If the user is not subscribed to an appropriate category, one may be created.

While any user can add any link to any category, a category editor approves the link before it is visible to anyone but the editors and the user who added the link. Once reviewing the link, category editors can decide to approve the link and include it in the general list or decline the link, in which case it becomes a private link for the adder alone.

Further, seasonal links, links that are temporarily down (or overloaded due to sudden popularity), links to be re-launched soon, or links that are otherwise uninteresting for a certain amount of time can be “snoozed.” These links are marked as new, and added to the “unread” list on the date specified by the user. The links will continue to appear in their category list (with a graphic designation of hibernation), but will not appear in meta categories—such as Best links or recent additions—until their “snooze” date has passed. For example, a user can snooze all of his NBA links after the Finals until the beginning of the next season, or film festival links until the next year's festival. Entire categories of links can be snoozed substantially simultaneously.

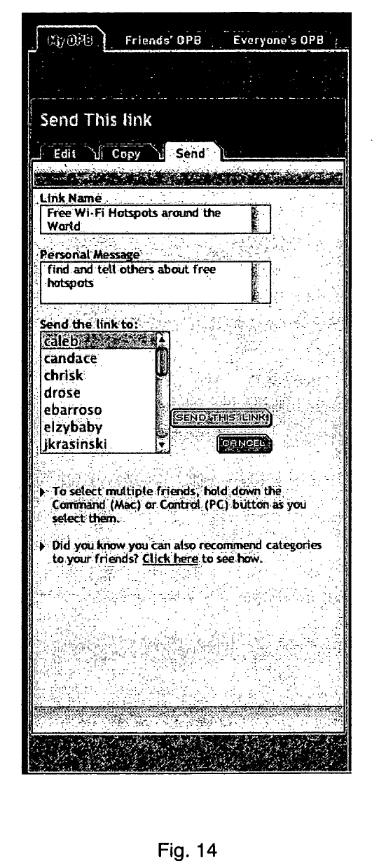

FIG. 14 illustrates the ability to send links to another user or users. The link is then copied to a meta category which acts as a link “inbox” for the receiving user. The user also has the option of receiving sent links via email.

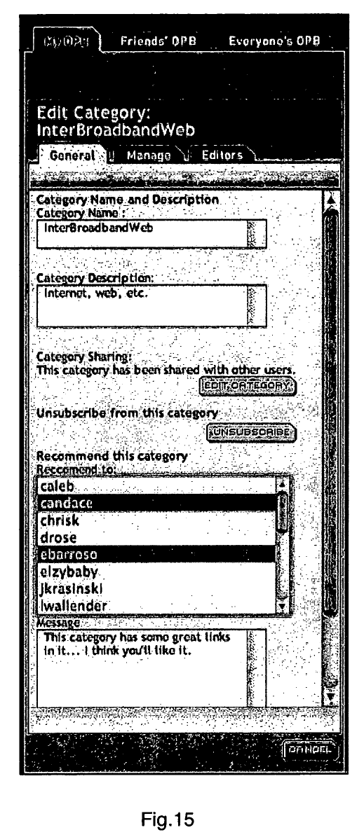

Further, in FIG. 15, a user can edit the description of the category. In any category listing, the user has the opportunity to subscribe or unsubscribe from the given category. Subscription adds the category to the user's category drop-down list, and may enable additional functionality for that category such as addition updates via e-mail, or link removal reporting, based on the user's preferences. Unsubscribing from a category removes it from the dropdown list, and will remove the links from the user's meta-categories, such as top links. If the user is an editor of the category, the editorship is resigned. If the user is the owner of the category, ownership is transferred to an editor of the user's choosing. If there are no other subscribers to the category, the category is removed and the links are either transferred to the user's default category, or deleted.

Users may recommend and invite other users to subscribe to a category. This invitation may arrive via a message within the site, or an outside communication source, such as an e-mail. Owners can invite users to subscribe to a category with editorial privileges already in place.

While the owner of each category has control over the contents of the owner's category, the owner may delegate that control to other users. Editors have the ability to add and delete links for public consumption without permission from the owner, as well as approve submissions from non-editors. Editors cannot change the name of the category, add new editors, or change the privacy permissions for the category.

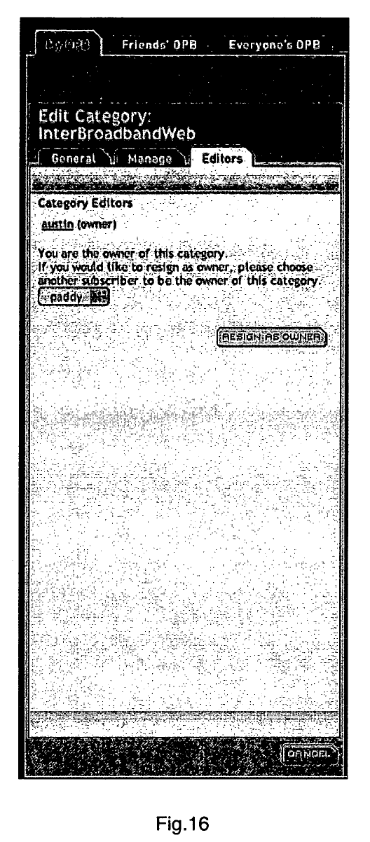

The owner of the category can have sole control over adding and subtracting editors, as shown in FIG. 16. The owner may choose from a list of subscribers, a list of nominated editors, or invite a user to become an editor. Non-owners may nominate users (including themselves) for editorship.

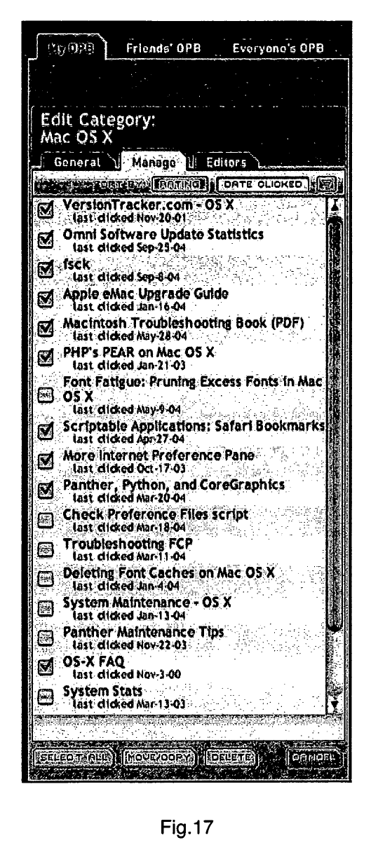

Referring to FIG. 17, users may manage multiple links at once. This functionality allows users to copy, move, or delete some or all of the links in the category at once. For example, if a user likes many of the links in the category, but the category is too high traffic for his tastes, he can copy all his favorite links to his own category. In another example, if a user creates a “sports” category that contains too many links, he can move all then basketball links to a category called “NBA”. If the user is an editor or owner of the category, an action like this could be coupled with a message to the subscribers alerting them to the change.

The database 10 provides automatic link archiving based on the last date clicked by a category subscriber. If a link has not been clicked on in over 60 days by one of the categories subscribers, the link is removed. Subscribers can choose to be notified of archived links via email or some other form. Editors would have the opportunity at that time to refresh the link, ensuring it remaining in the category for at least 60 more days. The owner of the category can set the number of days before auto-archiving. In addition, it can be specified that links with a default rating above a certain level not be archived.

This function enables users to add links whose interest may be short lived (such as sports box scores, or election results) as well as links that have much longer shelf life (such as a history of a certain sports team, or a candidate biography) without the expired links creating clutter in the category.

An additional function of the personalized public link database is to ensure the privacy of user data. For example, any link or category can have a privacy value associated with it that makes it visible to specific groups of users. Upon addition, they can be marked with one of four privacy values: (1) Private, i.e., can be viewed by the user; (2) These Users Only, i.e., can be viewed by specific users specified by the user; (3) Friends Only, i.e., can be viewed by people designated “friends” by the user; and (4) Public, i.e., can be viewed by anyone.

The owner of a category can change the privacy level at any time. Public categories that become private will automatically unsubscribe users that no longer have access to it. However, the owner of the category will have the option of creating a duplicate category with a different owner that will exist independently of new subscribers. The owner can also designate what links will exist in the new duplicate category.

The original contributor of a link can change the privacy level of a link at any time. The link will be removed from public display unless it has been moved, copied, or independently added by another user who would theoretically no longer have access to it.

Consumers of content can apply the same four levels of privacy to their associations with the content they click on, rate, and comment upon. For categories, this is specified when the user subscribes to a category, and can be changed later on the edit category screen. For links, this can be specified at any time on the edit link screen. In addition, global values can be set in the user preferences screen, although specific values will override the user preferences. This allows users to use OPB for more sensitive information, and still share links with specified groups of people.

Other embodiments of the invention include allowing the user to organize content for viewing in disparate programs in one central location. This includes managing links specifically for PDA/Smartfone usage, adding metadata to open certain sites with certain programs, and managing PVR functionality. Additionally, the development of cross platform browser-independent clients will enable content addition and management on PDA, PVR, Desktop computers, and other various computing sources. This client may have enhanced functionality, such as printing articles from a specified category or categories in one unified document, ready for binding—in essence, creating magazines of articles that users has pre-selected as wanting to read.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting.

1. A system for organizing data obtained over a network, the system comprising:
a user data manager configured to collect data associated with a first user of the system;
a category data manager configured to collect data related to a category, the category information being integrated with the data associated with the first user;
a link data manager configured to collect data associated with a link, the link providing access to content over the network; and
an input management subsystem in communication with the category data manager, the user data manager, and the link data manager and configured to sort data related to at least one of the link and the category based on a first user-specified preference.

2. The system of claim 1 further comprising a display management subsystem in communication with the input management subsystem and configured to manage an organization of the link within the category and present the organized data to the first user.

3. The system of claim 2 wherein the display management system is configured to present the organized data associated with the first user to a second user.

4. The system of claim 3 wherein the display management system is configured to limit a presentation of the organized data associated with the first user to the second user based on a privacy setting set by the first user.

5. The system of claim 2 wherein the category comprises a collection of links selected by the first user for presentation to the first user according to the at least one first user-specified preference.

6. The system of claim 5 wherein the user specified preference includes a rating assigned to the category to reflect a level of user interest in the category.

7. The system of claim 5 wherein the user-specified preference includes a rating assigned to the link to reflect a level of user interest in the link.

8. The system of claim 7 wherein the input management subsystem is further configured to filter data related to the link based on the rating assigned to the link.

9. The system of claim 5 wherein the user-specified preference includes an access count assigned to the link to reflect a level of user interest in the link.

10. The system of claim 9 wherein the input management subsystem is further configured to filter data related to the link based on the access count assigned to the link.

11. The system of claim 1 wherein the user-specified preference is reflected by a count of a number of times the user selects the category.

12. The system of claim 11 wherein the input management subsystem is further configured to filter data related to the category based on the count of the number of times the user selects the category.

13. The system of claim 1 wherein data associated with a user of the system includes user link preferences, user category preferences, and user identification.

14. A method of aggregating content obtained over a network for use by a user, the content being accessible via a link that is selected by the user, the method comprising:
extracting data associated with a first user and affiliated with a category determined by the first user, including data reflecting a status of the first user;
extracting category-specific data associated with the category;
retrieving a link based on a selection by the first user, the link providing a connection to content over the network; and
aggregating first user data, the category-specific information and the link such that the data is sorted by at least one of the category-specific data and the link data to provide content to the first user.

15. The method of claim 14 further comprising displaying a format of aggregated data related to at least one of the category-specific data and the link data to the first user.

16. The method of claim 14 further comprising sorting the category-specific data or the link data according to a status of the first user.

17. The method of claim 14 further comprising filtering the data according to one of a category rating, a link rating, or a privacy setting determined by a selection by the first user.

18. The method of claim 14 further comprising displaying a format of aggregated data related to at least one of the category-specific data and the link data to a second user.
